(19) United States
(12) Patent Application Publication
(10) Pub. No.: US 2013/0334893 A1
(43) Pub. Date: Dec. 19, 2013

(54) POWER TRANSMISSION SYSTEM AND POWER TRANSMITTING APPARATUS

(71) Applicant: MURATA MANUFACTURING CO., LTD., Nagaokakyo-Shi (JP)

(72) Inventor: Hironobu Takahashi, Nagaokakyo-Shi (JP)

(73) Assignee: MURATA MANUFACTURING CO., LTD., Nagaokakyo-Shi (JP)

(21) Appl. No.: 13/975,697

(22) Filed: Aug. 26, 2013

Related U.S. Application Data
(63) Continuation of application No. PCT/JP2012/063843, filed on May 30, 2012.

(30) Foreign Application Priority Data
Sep. 7, 2011 (JP) 2011-194533

(51) Int. Cl. H02J 17/00

(52) U.S. Cl. CPC H02J 17/00
USPC 307/104

(57) ABSTRACT

A power transmitting apparatus includes a power transmitting circuit, a passive electrode, and an active electrode. A capacitor represents a capacitance generated by the passive electrode and the active electrode. A voltage step-up circuit and the capacitor form a resonant circuit. The voltage step-up circuit formed of the step-up transformer and the inductor steps up a voltage generated by a voltage conversion circuit and applies the stepped up voltage between the passive electrode and the active electrode. A control IC performs PWM control of the voltage conversion circuit by comparing a rectified and smoothed voltage of a third winding of the step-up transformer with a reference voltage. As a result, an output voltage applied to the load circuit of a power receiving apparatus is stabilized without causing the power receiving apparatus to become complex or large.

### CROSS REFERENCE TO RELATED APPLICATIONS

The present application is a continuation of PCT/JP2012/063843 filed May 30, 2012, which claims priority to Japanese Patent Application No. 2011-194533, filed Sep. 7, 2011, the entire contents of each of which are incorporated herein by reference.

### FIELD OF THE INVENTION

The present invention relates to power transmission systems and power transmitting apparatuses included in the power transmission systems in which power is transmitted using electric field coupling.

### BACKGROUND OF THE INVENTION

In general, as disclosed in Patent Document 1, for example, wireless power transmission systems employ a method (electromagnetic field method) in which power is transmitted from a power-transmitting-unit-side primary winding to a load-unit-side secondary winding through an electromagnetic field. However, in wireless power transmission using an electromagnetic field method, since the magnitude of magnetic flux passing through the windings has a strong influence on the electromotive force, high accuracy is required in the positional relationship between the primary and secondary windings and a reduction in the size of the windings is difficult.

On the other hand, a method of power transmission (electric-field coupling method) is known in which power is transmitted from a power-transmitting-unit-side coupling electrode to a load-unit-side coupling electrode through an electric field, as disclosed in Patent Document 2, Patent Document 3, and Patent Document 4. Since wireless power transmission using an electric field coupling method uses an electric field between coupling electrodes, the required accuracy for the positional relationship between the coupling electrodes is reduced. Further, a reduction in the size of the coupling electrodes is realized. By using electric field coupling, freedom in the positional relationship between the transmitting and receiving electrodes and the orientation of the electrodes can be increased compared with a magnetic-field coupling method.

Patent Document 5 discloses a contactless power transmission system for a power of about several to several tens of watts in which a DC-DC converter is provided in a power receiving apparatus to apply a constant voltage to a load circuit.

FIG. 6 is a diagram illustrating the basic configuration of a power transmission system disclosed in Patent Document 2. This power transmission system includes a power transmitting apparatus and a power receiving apparatus. The power transmitting apparatus includes a power transmitting circuit 1, a passive electrode 2, and an active electrode 3. The power receiving apparatus includes a power receiving circuit 5, a passive electrode 7, and an active electrode 6. These two electrodes are coupled to each other through an electric field as a result of the active electrode 3 of the power transmitting apparatus and the active electrode 6 of the power receiving apparatus being arranged close to each other with a gap 4 therebetween.
Patent Document 1: Japanese Unexamined Patent Application Publication No. 11-40206
Patent Document 2: Japanese Unexamined Patent Application Publication (Translation of PCT Application) No. 2009-531009
Patent Document 3: Japanese Unexamined Patent Application Publication No. 2009-296857
Patent Document 4: Japanese Unexamined Patent Application Publication No. 2009-089520
Patent Document 5: Japanese Unexamined Patent Application Publication No. 2010-88143

As disclosed in Patent Document 5, when a DC-DC converter is provided in a power receiving apparatus, an output voltage applied to the load circuit of a power receiving apparatus can be stabilized. However, the circuit of the whole power receiving apparatus becomes complex.

In order to control the output voltage applied to the load circuit of the power receiving apparatus from a power transmitting apparatus side without providing a DC-DC converter in the power receiving apparatus, it is necessary for the power transmitting apparatus to monitor the output voltage applied to the load circuit of the power receiving apparatus using some means. In a wireless power transmission system, since a power transmitting apparatus is spaced apart from a power receiving apparatus, communication using some method is required for the power transmitting apparatus to detect the state of the power receiving apparatus. When a communication circuit is provided in the power receiving apparatus; the scale of the circuit increases and the cost also increases. In addition, since interference with a power transmitting unit is likely to occur, communication control becomes complicated.

Patent Document 3 discloses a configuration in which, in electric-field coupling power transmission, by measuring power supplied to a load, the constant of a resonant circuit is directly controlled. However, this is not a configuration for keeping an output voltage applied to the load circuit of a power receiving apparatus constant.

### SUMMARY OF THE INVENTION

It is an object of the present invention to provide an electric-field coupling power transmission system and a power transmitting apparatus that can stabilize an output voltage applied to a load of a power receiving apparatus without causing the power receiving apparatus to become complex or large.

(1) A power transmission system according to the present invention includes:

a power transmitting apparatus including power-transmitting-apparatus-side coupling electrodes formed of an active electrode and a passive electrode and including a power transmitting circuit that is connected to the power-transmitting-apparatus-side coupling electrodes and that supplies a high-frequency voltage; and

a power receiving apparatus including power-receiving-apparatus-side coupling electrodes that are formed of an active electrode and a passive electrode and that are coupled to the power-transmitting-apparatus-side coupling electrodes and including a power receiving circuit that is connected to the power-receiving-apparatus-side coupling electrodes and that supplies power to a load circuit.

The power transmitting circuit includes:

a voltage conversion circuit (voltage step-up converter) that outputs a voltage higher than a DC power supply voltage received by the voltage conversion circuit;

a DC-AC conversion circuit (inverter circuit) that converts the output voltage of the voltage conversion circuit into an AC voltage; and

a wire-wound step-up transformer that receives the output voltage of the DC-AC voltage conversion circuit and that forms, together with the power-transmitting-apparatus-side coupling electrodes, an LC resonant circuit.

(2) It is preferable to provide a control circuit that is provided on the power transmitting apparatus side and that controls a voltage conversion ratio of the voltage conversion circuit in such manner that a voltage between the power-transmitting-apparatus-side coupling electrodes becomes constant, by detecting a voltage applied between the power-transmitting-apparatus-side coupling electrodes.

(3) It is preferable that a detection point at which a voltage applied between the power-transmitting-apparatus-side coupling electrodes is detected be a secondary winding of the wire-wound step-up transformer.

(4) It is preferable that a detection point at which a voltage applied between the power-transmitting-apparatus-side coupling electrodes is detected be a primary winding of the wire-wound step-up transformer.

(5) It is preferable that a detection point at which a voltage applied between the power-transmitting-apparatus-side coupling electrodes is detected be a third winding of the wire-wound step-up transformer.

(6) A power transmitting apparatus according to the present invention forms a power transmission system together with a power receiving apparatus including power-receiving-apparatus-side coupling electrodes formed of an active electrode and a passive electrode and including a power receiving circuit which is connected to the power-receiving-apparatus-side coupling electrodes and supplies power to a load circuit, and the power transmitting apparatus includes:

power-transmitting-apparatus-side coupling electrodes that are formed of an active electrode and a passive electrode and that are coupled to the power-receiving-apparatus-side coupling electrodes and

a power transmitting circuit which is connected to the power-transmitting-apparatus-side coupling electrodes and which supplies a high-frequency voltage.

The power transmitting circuit includes:

a voltage conversion circuit (voltage step-up converter) that outputs a voltage higher than a DC power supply voltage received by the voltage conversion circuit;

a DC-AC conversion circuit (inverter circuit) that converts the output voltage of the voltage conversion circuit into an AC voltage; and

a wire-wound step-up transformer that receives the output voltage of the DC-AC conversion circuit and that forms, together with the power-transmitting-apparatus-side coupling electrodes, an LC resonant circuit.

According to the present invention, an output voltage applied to the load circuit of a power receiving apparatus can be stabilized without providing a DC-DC converter on the power receiving side. Further, the turns ratio of a step-up transformer can be decreased, whereby the transformer can be reduced in size and at the same time improved in terms of high-frequency characteristics, or is workable at a high-frequency range, while reducing parasitic capacitance generated in the secondary winding of the step-up transformer.

### BRIEF DESCRIPTION OF DRAWINGS

FIG. 1 is an equivalent circuit diagram of a power transmission system 401.

FIG. 2 is a simplified circuit diagram of a power transmission system 402 according to a second embodiment.

FIG. 3 is an equivalent circuit of the power transmission system 402.

FIG. 4 is a circuit diagram of a power transmission system 403 according to a third embodiment.

FIG. 5 is a circuit diagram of a power transmission system 404 according to a fourth embodiment.

FIG. 6 is a diagram illustrating the basic configuration of a power transmission system disclosed in Patent Document 2.

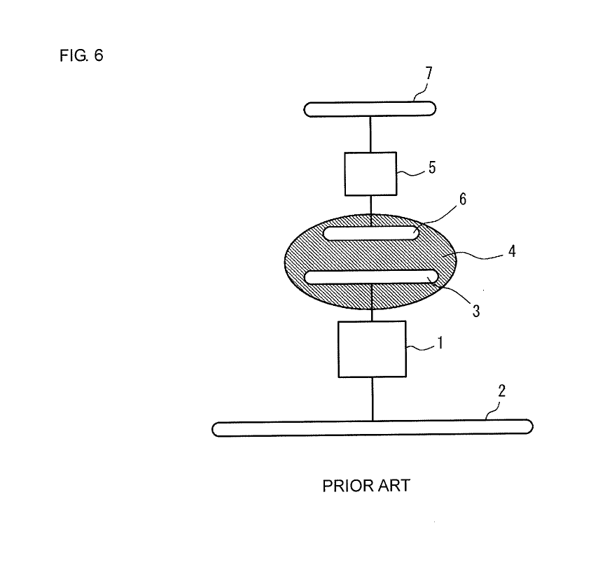

### DETAILED DESCRIPTION OF THE PREFERRED EMBODIMENTS OF THE INVENTION

### First Embodiment

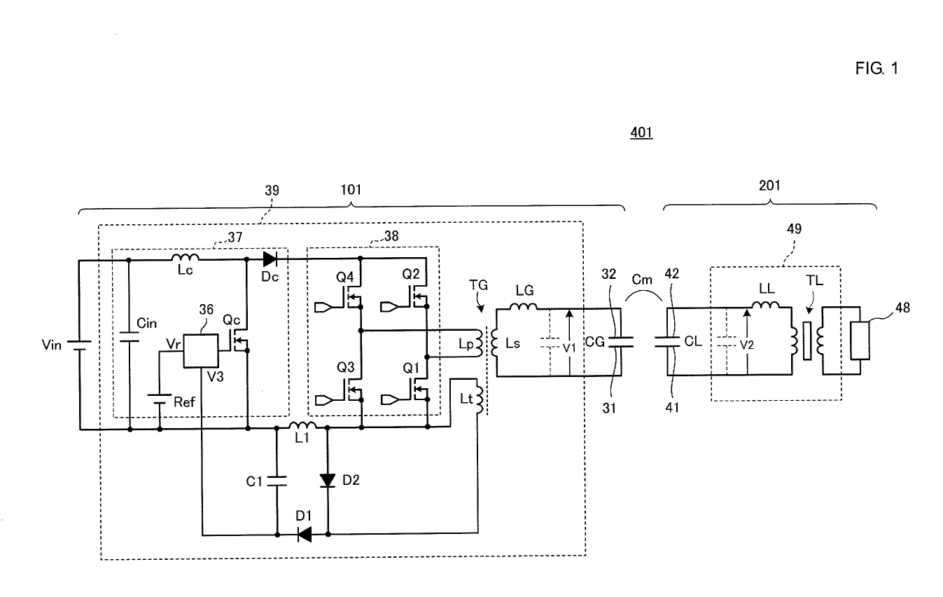

FIG. 1 is an equivalent circuit diagram of a power transmission system 401. In FIG. 1, a power transmitting apparatus 101 includes a power transmitting circuit 39, a passive electrode 31, and an active electrode 32. The passive electrode 31 and the active electrode 32 are power-transmitting-apparatus-side coupling electrodes. The power transmitting circuit 39 is formed of a step-up transformer TG, an inductor LG, a DC-AC conversion circuit 38, and a voltage conversion circuit 37. The DC-AC conversion circuit 38 generates, for example, a high-frequency voltage of a hundred kHz to several tens of MHz. A voltage step-up circuit formed of the step-up transformer TG and the inductor LG steps up a voltage generated by the DC-AC conversion circuit 38 and applies the stepped-up voltage between the passive electrode 31 and the active electrode 32. A capacitor CG represents a capacitance generated by the passive electrode 31 and the active electrode 32. The voltage step-up circuit and the capacitor CG form a resonant circuit.

A power receiving apparatus 201 includes a passive electrode 41, an active electrode 42, a power receiving circuit 49, and a load circuit 48. The passive electrode 41 and the active electrode 42 are power-receiving-apparatus-side coupling electrodes. The power receiving circuit 49 is formed of a voltage step-down circuit, including a step-down transformer TL and an inductor LL, and the like. The voltage step-down circuit formed of the step-down transformer TL and the inductor LL is connected between the passive electrode 41 and the active electrode 42. A capacitor CL represents a capacitance generated by the passive electrode 41 and the active electrode 42. The voltage step-down circuit and the capacitor CL form a resonant circuit. The load circuit 48 is connected to the secondary side of the step-down transformer TL.

A DC power supply voltage is input to the power transmitting circuit 39 by a DC power supply Vin. A capacitor Cin is an input filter.

The DC-AC conversion circuit 38 is a circuit in which switching devices Q1 to Q4 are connected so as to form a bridge circuit. A switching control circuit, although not illustrated, is connected to the gates of the switching devices Q1 to Q4. This switching control circuit alternately repeats a period during which Q1 and Q4 are on and Q2 and Q3 are off and a period in which Q1 and Q4 are off and Q2 and Q3 are on, with a duty ratio of 50%.

The DC-AC conversion circuit 38, together with the primary winding of the step-up transformer TG, form an inverter circuit.

The voltage conversion circuit 37 forms a voltage step-up converter (voltage step-up chopper) including an inductor Lc, a switching device Qc composed of a MOSFET, and a diode Dc. The switching device Qc is driven by a control IC 36. The operation of this voltage conversion circuit will be described later.

When the power receiving apparatus 201 is mounted on the power transmitting apparatus 101, the active electrodes of the power transmitting apparatus 101 and the power receiving apparatus 201 are capacitively coupled to each other, and the passive electrodes of the power transmitting apparatus 101 and the power receiving apparatus 201 are capacitively coupled to each other, whereby power can be transmitted from the power transmitting apparatus 101 to the power receiving apparatus 201.

In the power transmitting apparatus 101, the step-up transformer TG of the power transmitting circuit 39 includes a third winding Lt, and a rectifying and smoothing circuit formed of diodes D1 and D2, an inductor Li, and a capacitor C1 is connected to the third winding Lt. The turns ratio between a primary winding Lp and the third winding Lt of the step-up transformer TG is, for example, about 2:1 to 1:2.

The output voltage across the third winding Lt, which is transformer-coupled to the primary winding Lp and a secondary winding Ls, changes in accordance with a change in the input voltage on the power transmitting apparatus side and a change in the output voltage applied to the load circuit of the power receiving apparatus. Freedom in the circuit design is increased by appropriately setting the turns ratio of the windings.

The control IC 36 that controls the voltage conversion circuit 37 performs PWM control of the voltage conversion circuit 37 in accordance with the result of comparison of an output voltage V3 of the rectifying and smoothing circuit with a reference voltage Vr generated by a reference voltage generating circuit Ref. This control is feedback control through which the voltage V3 is made to become equal to the reference voltage Vr. Specifically, the on-period of the switching device Qc of the voltage conversion circuit 37 is decreased when V3>Vr, and the on-period of the switching device Qc of the voltage conversion circuit 37 is increased when V3<Vr.

A voltage V1 between the power-transmitting-apparatus-side coupling electrodes 31 and 32 is maintained at a constant voltage by the feedback control. As a result, a voltage. V2 between the power-receiving-apparatus-side coupling electrodes 41 and 42 is also maintained constant.

The voltage V2 between the power-receiving-apparatus-side coupling electrodes 41 and 42 changes in accordance with the magnitude of the load (magnitude of the load current) of the load circuit 48. Since the coupling electrodes 31 and 32 are coupled to the coupling electrodes 41 and 42 through an electric field, the voltage V1 between the power-transmitting-apparatus-side coupling electrodes 31 and 32 also changes in accordance with the change in the voltage V2. When the voltage V1 changes, the voltage across the secondary winding Ls of the step-up transformer TG changes. Hence, the voltage V3, which is the rectified and smoothed voltage of a voltage generated across the transformer-coupled third winding Lt also changes. As a result, through feedback control which makes the voltage V3 constant, the output voltage applied to the load circuit 48 of the power receiving apparatus 201 can be stabilized.

In this manner, there is no need to provide a special voltage stabilizing circuit, such as a DC-DC converter, in the power receiving apparatus, whereby the configuration of the power receiving apparatus can be simplified.

Further, as a result of the voltage step-up converter being provided in a stage prior to the step-up transformer, the turns ratio of the step-up transformer can be decreased and parasitic capacitance generated in the secondary winding of the step-up transformer can be reduced, thereby the transformer can be reduced in size and at the same time improved in terms of high-frequency characteristics.

Further, since the voltage applied to the DC-AC conversion circuit 38 (inverter circuit) is controlled using the voltage conversion circuit 37 rather than a generated voltage being controlled using pulse-width modulation (PWM) control of the inverter circuit, the DC-AC conversion circuit 38 (inverter circuit) can always generate an alternating voltage at a duty ratio of 50%. As a result, a resonant waveform in the resonant circuit that is formed of the voltage step-up circuit and the capacitor CG of the power transmitting apparatus 101 and a resonant waveform in the resonant circuit that is formed of the voltage step-down circuit and the capacitor CL of the power receiving apparatus 201 have small distortion. Hence, substantially sine-wave-shaped power can be transmitted, whereby undesirable radiation and noise due to generation of harmonic components are reduced.

### Second Embodiment

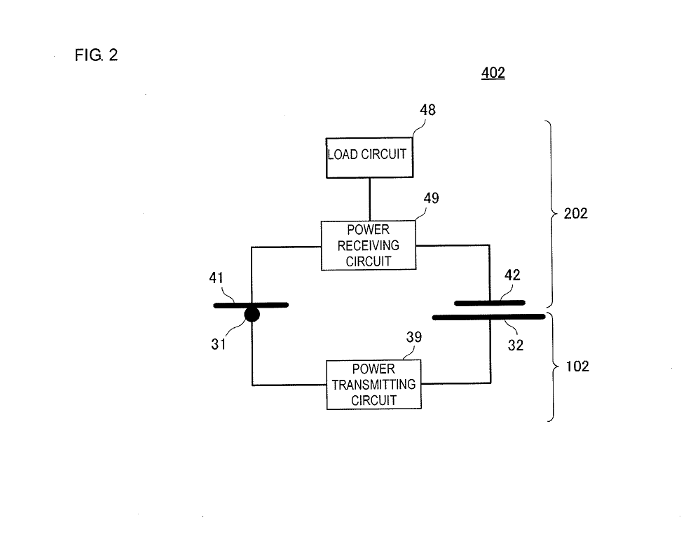

FIG. 2 is a simplified circuit diagram of a power transmission system 402 according to a second embodiment. The power transmission system 402 includes a power transmitting apparatus 102 and a power receiving apparatus 202. The power transmitting apparatus 102 includes a power-transmitting-apparatus-side passive electrode 31 and a power-transmitting-apparatus-side active electrode 32, and the power receiving apparatus 202 includes a power-receiving-apparatus-side passive electrode 41 and a power-receiving-apparatus-side active electrode 42.

A power transmitting circuit 39 is connected between the power-transmitting-apparatus-side active electrode 32 and the power-transmitting-apparatus-side passive electrode 31. A power receiving circuit 49 is connected between the power-receiving-apparatus-side active electrode 42 and the power-receiving-apparatus-side passive electrode 41, and a load circuit 48 is connected to the power receiving circuit 49.

The power transmitting circuit 39 applies a high-frequency voltage between the power-transmitting-apparatus-side active electrode 32 and the power-transmitting-apparatus-side passive electrode 31. The power receiving circuit 49 steps down a voltage generated between the power-receiving-apparatus-side active electrode 42 and the power-receiving-apparatus-side passive electrode 41. The load circuit 48 receives, as a power supply voltage, the output voltage of the power receiving circuit 49 applied to the load circuit 48. The load circuit 48 includes a rectifying and smoothing circuit that rectifies and smoothes the output of the power receiving circuit 49, a secondary battery charged by the output of the rectifying and smoothing circuit, and the like.

The power-receiving-apparatus-side passive electrode 41 and the power-transmitting-apparatus-side passive electrode 31 are in contact with each other, and have a DC electrical connection therebetween.

According to the second embodiment, since power is transmitted at a stepped-up high voltage, a current flowing through the power-transmitting-apparatus-side passive electrode 31 is of the order of, for example, several milliamperes and the influence of the contact resistance of the power-transmitting-apparatus-side passive electrode is very small. Hence, there is no need to make the contact resistance low. As a result, various means for the contact, such as conductive rubber, can be used.

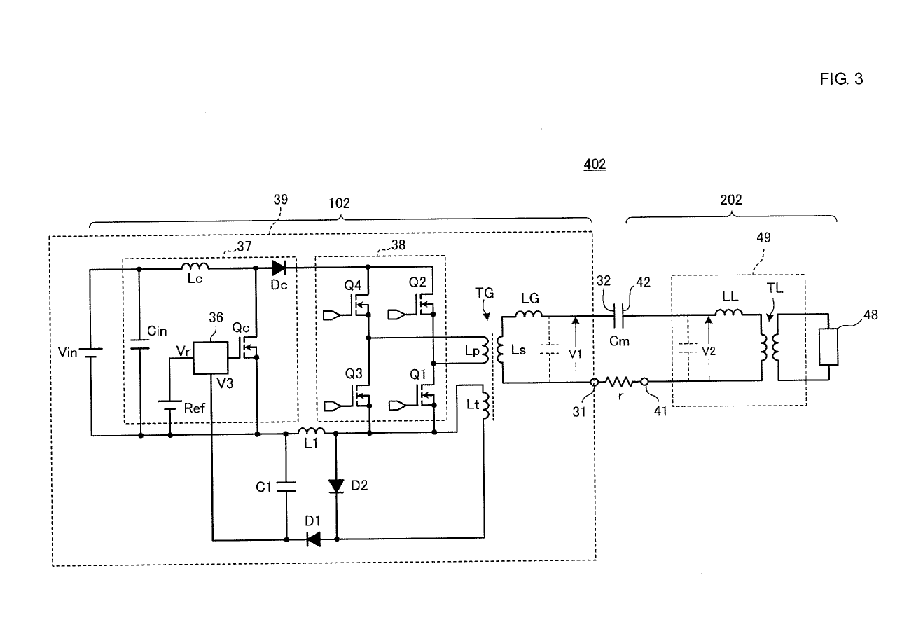

FIG. 3 is an equivalent circuit of the power transmission system 402. A resistor r connected between the power-transmitting-apparatus-side passive electrode 31 and the power-receiving-apparatus-side passive electrode 41 corresponds to a contact resistance formed at the contact portion between the power-transmitting-apparatus-side passive electrode 31 and the power-receiving-apparatus-side passive electrode 41. A capacitor Cm connected between the power-transmitting-apparatus-side active electrode 32 and the power-receiving-apparatus-side active electrode 42 corresponds to a capacitance generated between the power-transmitting-apparatus-side active electrode 32 and the power-receiving-apparatus-side active electrode 42. The rest of the configuration is the same as that of the power transmission system 401.

Supposing that a resistance value of the contact resistor r is r, a capacitance value of the capacitor Cm at the coupling portion is Cm, and an angular frequency is w, the relation r<<1/ωCm holds. In this manner, since the passive electrodes of the power transmitting apparatus 102 and the power receiving apparatus 202 are directly electrically connected to each other, the potential of the power-receiving-apparatus-side passive electrode 41 becomes approximately equal to the potential of the power-transmitting-apparatus-side passive electrode 31. As a result, the potential of the power-receiving-apparatus-side passive electrode 41 is stabilized, whereby variations in the ground potential and leakage of undesired electromagnetic field are suppressed. Further, since stray capacitance is suppressed, the degree of coupling is increased, whereby high transmission efficiency is obtained.

In this manner, when the power receiving apparatus 202 is mounted on the power transmitting apparatus 102, the active electrodes of the power transmitting apparatus 102 and the power receiving apparatus 202 are capacitively coupled to each other and the passive electrodes of the power transmitting apparatus 102 and the power receiving apparatus 202 are directly electrically connected to each other, whereby power can be transmitted from the power transmitting apparatus 102 to the power receiving apparatus 202.

### Third Embodiment

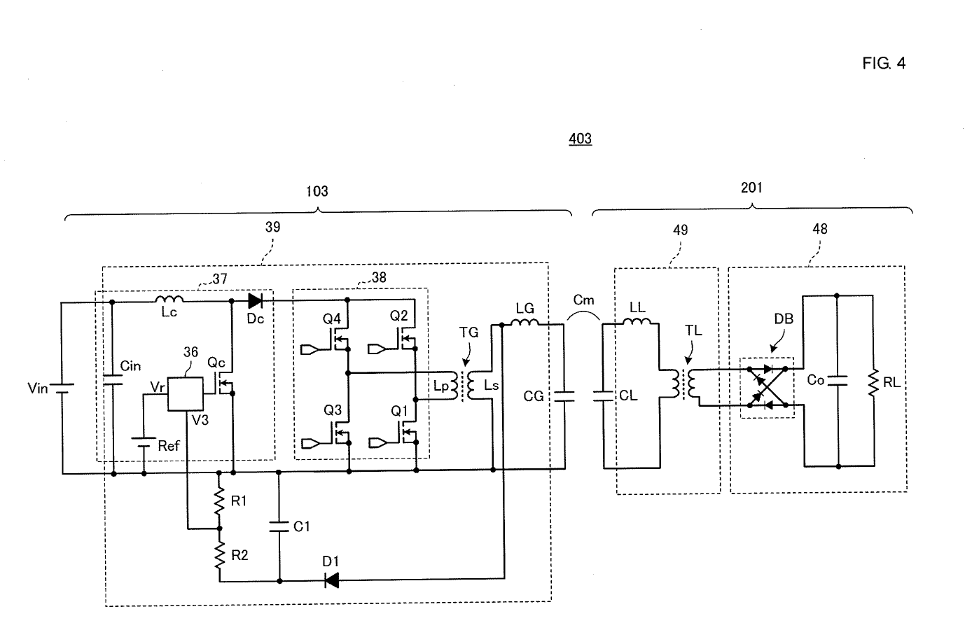

FIG. 4 is a circuit diagram of a power transmission system 403 according to a third embodiment. The power transmission system 403 includes a power transmitting apparatus 103 and a power receiving apparatus 201. A capacitor CG represents a capacitance generated by a passive electrode and an active electrode forming power-transmitting-apparatus-side coupling electrodes. A capacitor CL represents a capacitance generated by a passive electrode and an active electrode forming power-receiving-apparatus-side coupling electrodes.

The configuration of the power receiving apparatus 201 is the same as that of the power receiving apparatus described in the first embodiment. Here, a load circuit 48 of the power receiving apparatus 201 is formed of a diode bridge DB, a smoothing capacitor Co, and a load RL.

The configuration of the power transmitting apparatus 103 is about the same as that of the power transmitting apparatus 101 described in the first embodiment. A point at which a signal is taken out by a wiring line used for feedback to a voltage conversion circuit 37 (voltage step-up converter) is different from that in the power transmitting apparatus 101.

The output terminals of an inverter circuit which is formed of a bridge connection circuit including switching devices Q1 to Q4 are connected to a primary winding Lp of a step-up transformer TG of a power transmitting circuit 39.

A rectifying and smoothing circuit formed of a diode D1 and a capacitor C1 and a voltage divider circuit formed of resistors R1 and R2 are connected to a secondary winding Ls of the step-up transformer TG. The voltage across the secondary winding Ls of the step-up transformer TG is converted into a DC voltage by the rectifying and smoothing circuit, divided by the voltage divider circuit formed of the resistors R1 and R2, and input to a control IC 36 as a voltage V3. A reference voltage generating circuit Ref generates a reference voltage Vr, which is input to the control IC 36.

The control IC 36 compares the voltage V3 with the reference voltage Vr, and performs PWM control of a switching device Qc of the voltage step-up converter in accordance with the comparison result. The voltage conversion ratio of the voltage step-up converter is controlled by this PWM control. This control is feedback control through which the voltage V3 is made to become equal to the reference voltage Vr. Specifically, the on-period of the switching device Qc is decreased when V3>Vr, and the on-period of the switching device Qc is increased when V3<Vr. As a result, the output voltage of the power transmitting apparatus 103 is maintained constant.

In this manner, variations in the output voltage applied to the load circuit 48 of the power receiving apparatus 201 can be detected with high sensitivity by detecting the voltage of the secondary winding of the step-up transformer TG.

Further, as described in the first embodiment, since the voltage applied to a DC-AC conversion circuit 38 (inverter circuit) is controlled using the voltage conversion circuit 37 rather than a generated voltage being controlled using pulse-width modulation (PWM) control of the inverter circuit, the DC-AC conversion circuit 38 (inverter circuit) can always generate an alternating voltage at a duty ratio of 50%. Hence, substantially sine-wave-shaped power can be transmitted, whereby undesirable radiation and noise due to generation of harmonic components are reduced.

Further, since a third winding is not provided in the step-up transformer TG, the step-up transformer TG can be reduced in size.

### Fourth Embodiment

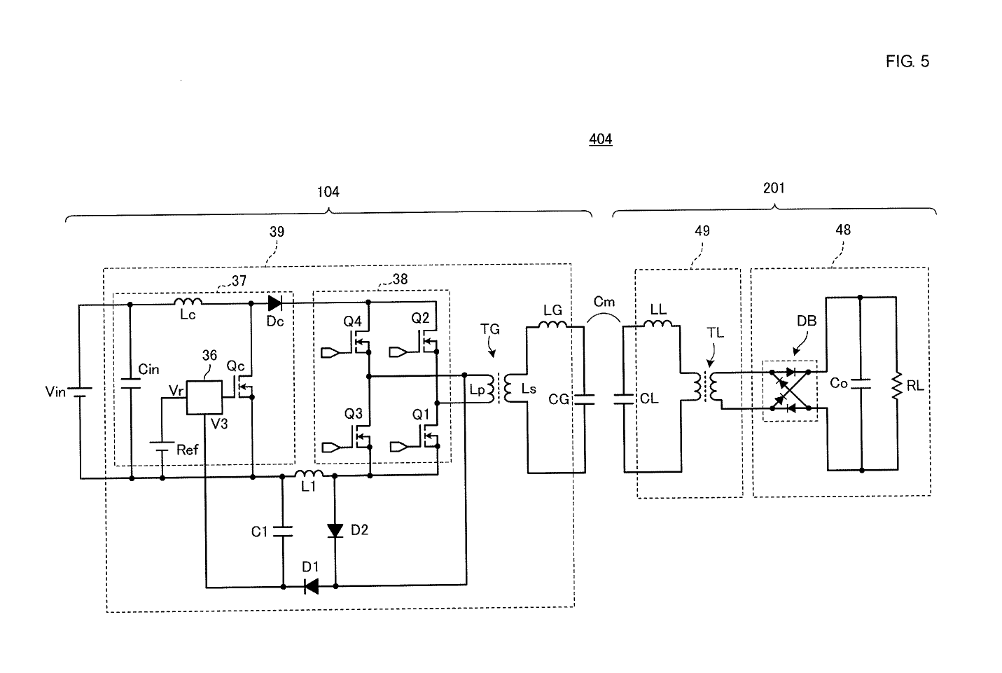

FIG. 5 is a circuit diagram of a power transmission system 404 according to a fourth embodiment. The power transmission system 404 includes a power transmitting apparatus 104 and a power receiving apparatus 201. A capacitor CG represents a capacitance generated by a passive electrode and an active electrode forming power-transmitting-apparatus-side coupling electrodes. A capacitor CL represents a capacitance generated by a passive electrode and an active electrode forming power-receiving-apparatus-side coupling electrodes.

The configuration of the power receiving apparatus 201 is the same as that of the power receiving apparatus illustrated in the first embodiment. Here, a load circuit 48 of the power receiving apparatus 201 is formed of a diode bridge DB, a smoothing capacitor Co, and a load RL.

A rectifying and smoothing circuit formed of diodes D1 and D2 and a capacitor C1 is connected to a primary winding Lp of a step-up transformer TG. The voltage of the primary winding Lp of the step-up transformer TG is converted into a DC voltage by a rectifying and smoothing circuit and input to a control IC 36 as a voltage V3. A reference voltage generating circuit Ref generates a reference voltage Vr, which is input to the control IC 36. The rest of the configuration is the same as that illustrated in FIG. 4.

The control IC 36 compares the voltage V3 with the reference voltage Vr, and performs PWM control of a switching device Qc of the voltage step-up converter in accordance with the comparison result.

In this manner, by detecting the voltage across the primary winding Lp of the step-up transformer TG, the output voltage applied to the load circuit of the power receiving apparatus can be indirectly monitored without affecting the resonance generated by the secondary winding Ls of the step-up transformer TG, an inductor LG, and the capacitor CG.

### REFERENCE SIGNS LIST

DB diode bridge
Lp primary winding
Ls secondary winding
Lt third winding
Q1-Q4 switching devices
Qc switching device
r resistor
Ref reference voltage generating circuit
RL load
TG step-up transformer
TL step-down transformer
Vin DC power supply
Vr reference voltage
31 power-transmitting-apparatus-side passive electrode
32 power-transmitting-apparatus-side active electrode
(31, 32) power-transmitting-apparatus-side coupling electrodes
36 control IC
37 voltage conversion circuit
38 DC-AC conversion circuit
39 power transmitting circuit
41 power-receiving-apparatus-side passive electrode
42 power-receiving-apparatus-side active electrode
(41, 42) power-receiving-apparatus-side coupling electrodes
48 load circuit
49 power receiving circuit
101-104 power transmitting apparatuses
201, 202 power receiving apparatuses
401-404 power transmission systems

1. A power transmission system comprising:
a power transmitting apparatus including:
a power-transmitting coupling electrode having an active electrode and a passive electrode, and
a power transmitting circuit configured to supply a high-frequency voltage to the power-transmitting coupling electrode; and
a power receiving apparatus including:
power-receiving coupling electrode having an active electrode and a passive electrode, and
a power receiving circuit coupled to the power-receiving coupling electrode and configured to supply power to a load circuit,
wherein the power transmitting circuit includes:
a voltage conversion circuit configured to receive a DC power supply voltage and to output a voltage higher than the DC power supply voltage,
a DC-AC conversion circuit configured to convert the voltage output from the voltage conversion circuit into an AC voltage, and
a step-up transformer configured to step up the AC voltage and apply the stepped up voltage between the active electrode and the passive electrode of the power transmitting apparatus.

2. The power transmission system according to claim 1, wherein the step-up transformer and the power-transmitting coupling electrode form an LC resonant circuit.

3. The power transmission system according to claim 1, wherein the power transmitting apparatus further comprises a control circuit configured to control a voltage conversion ratio of the voltage conversion circuit such that the stepped up voltage applied between the active electrode and the passive electrode of the power-transmitting coupling electrode becomes constant.

4. The power transmission system according to claim 3, wherein the control circuit controls the voltage conversion ratio of the voltage Conversion circuit by detecting the stepped up voltage applied between the active electrode and the passive electrode of the power-transmitting coupling electrode.

5. The power transmission system according to claim 4, wherein a detection point for the detected stepped up voltage is a secondary winding of the step-up transformer.

6. The power transmission system according to claim 4, wherein a detection point for the detected stepped up voltage is a primary winding of the step-up transformer.

7. The power transmission system according to claim 4, wherein a detection point for the detected stepped up voltage is a third winding of the step-up transformer.

8. The power transmission system according to claim 4, wherein the DC-AC conversion circuit comprises a switching device.

9. The power transmission system according to claim 8, wherein the control circuit is configured to:
compare the detected stepped up voltage with a reference voltage,
decrease an on-period of the switching device if the detected stepped up voltage is greater than the reference voltage, and
increase the on-period of the switching device if the detected stepped up voltage is less than the reference voltage.

10. The power transmission system according to claim 1, further comprising:
a resistor coupled between the passive electrode of the power transmitting apparatus and the passive electrode of the power receiving apparatus; and
a capacitor coupled between the active electrode of the power transmitting apparatus and the active electrode of the power receiving apparatus.

11. A power transmitting apparatus configured to supply power to a power receiving apparatus having an active electrode and a passive electrode, the power transmitting apparatus comprising:
a power-transmitting coupling electrode having an active electrode and a passive electrode; and
a power transmitting circuit configured to supply a high-frequency voltage to the power-transmitting coupling electrode, the power transmitting circuit including:
a voltage conversion circuit configured to receive a DC power supply voltage and to output a voltage higher than the DC power supply voltage,
a DC-AC conversion circuit configured to convert the voltage output from the voltage conversion circuit into an AC voltage, and
a step-up transformer configured to step up the AC voltage and apply the stepped up voltage between the active electrode and the passive electrode.

12. The power transmitting apparatus according to claim 11, wherein the step-up transformer and the power-transmitting coupling electrode form an LC resonant circuit.

13. The power transmitting apparatus according to claim 11, wherein the power transmitting apparatus further comprises a control circuit configured to control a voltage conversion ratio of the voltage conversion circuit such that the stepped up voltage applied between the active electrode and the passive electrode becomes constant.

14. The power transmitting apparatus according to claim 13, wherein the control circuit controls the voltage conversion ratio of the voltage conversion circuit by detecting the stepped up voltage applied between the active electrode and the passive electrode.

15. The power transmitting apparatus according to claim 14, wherein a detection point for the detected stepped up voltage is a secondary winding of the step-up transformer.

16. The power transmitting apparatus according to claim 14, wherein a detection point for the detected stepped up voltage is a primary winding of the step-up transformer.

17. The power transmitting apparatus according to claim 14, wherein a detection point for the detected stepped up voltage is a third winding of the step-up transformer.

18. The power transmitting apparatus according to claim 14, wherein the DC-AC conversion circuit comprises a switching device.

19. The power transmitting apparatus according to claim 18, wherein the control circuit is configured to:
compare the detected stepped up voltage with a reference voltage,
decrease an on-period of the switching device if the detected stepped up voltage is greater than the reference voltage, and
increase the on-period of the switching device if the detected stepped up voltage is less than the reference voltage.

20. The power transmitting apparatus according to claim 11, further comprising:
a resistor coupled between the passive electrode of the power transmitting apparatus and the passive electrode of the power receiving apparatus; and
a capacitor coupled between the active electrode of the power transmitting apparatus and the active electrode of the power receiving apparatus.
